(19) United States
(12) Patent Application Publication
(10) Pub. No.: US 2023/0289404 A1
(43) Pub. Date: Sep. 14, 2023

(54) INFORMATION PROCESSING APPARATUS AND INFORMATION PROCESSING METHOD

(71) Applicant: Sony Group Corporation, Tokyo (JP)

(72) Inventor: Justinas MISEIKIS, Stuttgart (DE)

(73) Assignee: Sony Group Corporation, Tokyo (JP)

(21) Appl. No.: 18/115,812

(22) Filed: Mar. 1, 2023

(30) Foreign Application Priority Data
Mar. 8, 2022 (EP) 22160869.8

(51) Int. Cl. G06F 18/241; G06N 20/00

(52) U.S. Cl. CPC G06F 18/241; G06N 20/00

(57) ABSTRACT

The present disclosure is directed to an information processing apparatus which includes a target information obtainer configured to obtain target information of a target individual, wherein the target information includes image information, a communication behavior classifier configured to determine, based on the target information, a communication behavior class of the target individual, a direct behavior information determiner configured to determine, based on the target information, direct behavior information about the target individual, an indirect behavior information determiner configured to determine, based on the communication behavior class and the direct behavior information, indirect behavior information of the target individual, and an explanator configured to obtain, based on a communication behavior class of a user, explanatory information regarding the indirect behavior information and provide the explanatory information to the user. Further, the present disclosure is directed to a corresponding information processing method.

### CROSS-REFERENCE TO RELATED APPLICATION

The present application claims priority to European Patent Application No. 22160869.8, filed Mar. 8, 2022, the entire contents of which are incorporated herein by reference.

### TECHNICAL FIELD

The present disclosure generally pertains to information processing apparatus and a corresponding information processing method.

### TECHNICAL BACKGROUND

Generally, it is known that many cultures use specific body language that is used in respective regions to enhance communication between individuals and groups. As this is not unique to humans only, animals also have body language indicating, e.g. their mood, intentions, levels of joy/aggression, or the like.

When learning a foreign language, one usually struggles to communicate in initial encounters with native speakers of the language. It therefore comes down to body language which is an inseparable feature of the culture of the native speaker. Only after spending enough time with people from the culture, the communication becomes smooth and maybe even effortless for the foreign speaker as he/she understands the cultural differences and body language. However, the same body language can have different meanings depending on the culture, which could lead to misunderstandings. For example, in Japanese culture, raising a hand with the palm towards another person while moving the fingers up and down in unison indicates an invitation/summon to come or join, whereas the same gesture could indicate a greeting in European cultures.

Similarly, different animals can express their mood or intentions through body language. Here again, even the same body language can have a different, if not opposite, meanings depending on the animal. For example, wagging the tail indicates joy to dogs but anger to cats.

Although there exist techniques for improving communication between different cultures and between humans and animals, it is generally desirable to improve these existing techniques.

### SUMMARY

According to a first aspect, the disclosure provides an information processing apparatus comprising:
a target information obtainer configured to obtain target information of a target individual, wherein the target information includes image information;
a communication behavior classifier configured to determine, based on the target information, a communication behavior class of the target individual;
a direct behavior information determiner configured to determine, based on the target information, direct behavior information about the target individual;
an indirect behavior information determiner configure to determine, based on the communication behavior class and the direct behavior information, indirect behavior information of the target individual; and
an explanator configured to obtain, based on a communication behavior class of a user, explanatory information regarding the indirect behavior information and provide the explanatory information to the user.

According to a second aspect, the disclosure provides an information processing apparatus comprising:
obtaining target information of a target individual, wherein the target information includes image information;
determining, based on the target information, a communication behavior class of the target individual;
determining, based on the target information, direct behavior information about the target individual;
determining, based on the communication behavior class and the direct behavior information, indirect behavior information of the target individual; and
obtaining, based on a communication behavior class of a user, explanatory information regarding the indirect behavior information and providing the explanatory information to the user.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates, in a block diagram, a first embodiment of an information processing apparatus;

FIG. 2 schematically illustrates a table an embodiment of association of direct behavior information, communication behavior classes and indirect behavior information;

FIG. 3 schematically illustrates, in a block diagram, a second embodiment of an information processing apparatus;

FIG. 4 schematically illustrated, in a flow diagram, an embodiment of an information processing method; and

FIG. 5 schematically illustrates, in a block diagram, a general-purpose computer which can be used for implementing an information processing system.

### DETAILED DESCRIPTION OF EMBODIMENTS

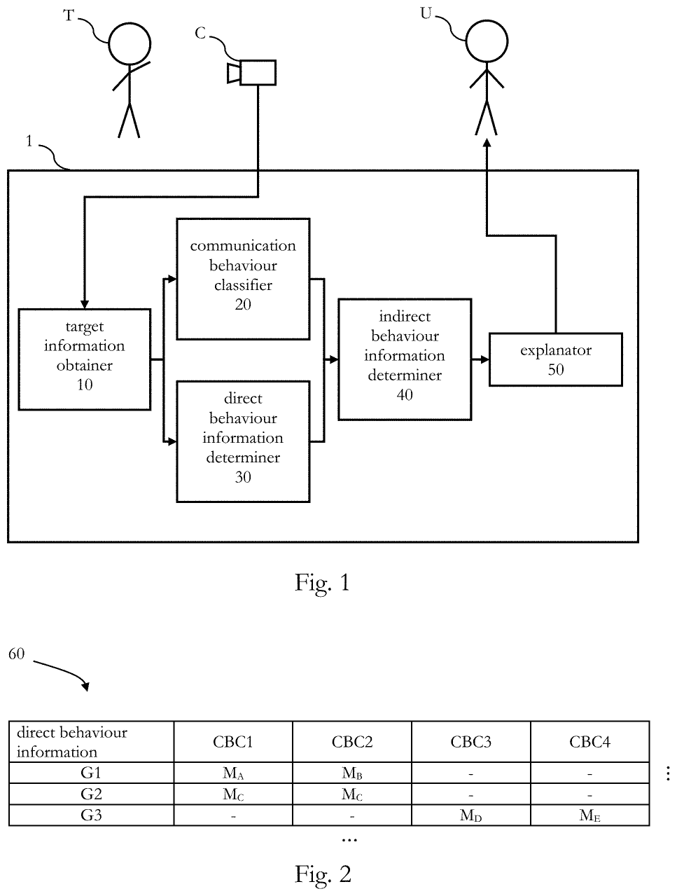

Before a detailed description of the embodiments under reference of FIG. 1 is given, general explanations are made.

As set forth in the outset, generally, it is known that many cultures use specific body language that is used in respective regions to enhance communication between at least one individuals and groups.

As this is not unique to humans only, animals also have body language indicating, e.g. their mood, intentions, levels of joy or aggression, or the like.

When learning a foreign language, one usually struggles to communicate in initial encounters with native speakers of the language. It therefore comes down to body language which is an inseparable feature of the culture of the native speaker. Only after spending enough time with people from the culture, the communication becomes smooth and maybe even effortless for the foreign speaker as he/she understands the cultural differences and body language. However, the same body language can have different meanings depending on the culture, which could lead to misunderstandings. For example, in Japanese culture, raising a hand with the palm towards another person while moving the fingers up and down in unison indicates an invitation/summon to come or join, whereas the same gesture could indicate a greeting in European cultures.

Similarly, different animals can express their mood or intentions through body language. Here again, even the same body language can have a different, if not opposite, meanings depending on the animal. For example, wagging the tail indicates joy to dogs but anger to cats.

Although there exist techniques for improving communication between different cultures and between humans and animals, it is generally desirable to improve these existing techniques.

It has been recognized that more emphasis should be put into understanding body language in order to improve communication between two individuals in some instances.

Hence, some embodiments pertain to an information processing apparatus including:
a target information obtainer configured to obtain target information of a target individual, wherein the target information includes image information;
a communication behavior classifier configured to determine, based on the target information, a communication behavior class of the target individual;
a direct behavior information determiner configured to determine, based on the target information, direct behavior information about the target individual;
an indirect behavior information determiner configure to determine, based on the communication behavior class and the direct behavior information, indirect behavior information of the target individual; and
an explanator configured to obtain, based on a communication behavior class of a user, explanatory information regarding the indirect behavior information and provide the explanatory information to the user.

The information processing apparatus may use visual inputs obtained, for example, by a camera, and, optionally, audio inputs of a situation containing one or more humans or animals. Depending on the context, for example, genus of animal, or culture of the person, the information processing apparatus analyzes the obtained visual cues (with optional audio inputs if needed/available) to understand the state and/or intentions of the observed and would provide the user with additional information about the interaction and possibly provide suggestions on how to act in the given situation.

The information processing apparatus may be based on or may be implemented on a computer, a wearable device (e.g. head mounted device such as augmented reality glasses), a server, a cloud service, or the like. The information processing apparatus may be embedded in a media device such as a television, a home entertainment system (e.g. including a television, a gaming console, a receiver box of a provider, a camera, a microphone, a speaker etc.), a mobile device or the like. The information processing apparatus may be based on or may be implemented based on a distributed architecture, for example, distributed across a server, a cloud service, or the like and a media device such that some of its functions are performed by a server or the like and some of its functions are performed by the media device.

Generally, the information processing apparatus includes circuitry configured to achieve the functions as described herein. The circuitry may be based on or may be implemented based on a distributed architecture, for example, distributed across a server, a cloud service, or the like and a media device.

The circuitry may be based on or may include or may be implemented as integrated circuitry logic or may be implemented by one or more CPUs (central processing unit), one or more application processors, one or more graphical processing units (GPU), one or more machine learning units such as tensor processing unit (TPU), one or more microcontrollers, one or more FPGAs (field programmable gate array), one or more ASICs (application specific integrated circuit) or the like. The functionality may be implemented by software executed by a processor such as an application processor or the like. The circuitry may be based on or may include or may be implemented by typical electronic components configured to achieve the functionality as described herein. The circuitry may be based on or may include or may be implemented in parts by typical electronic components and integrated circuitry logic and in parts by software.

The circuitry may include a communication interface configured to communicate and exchange data with a computer or processor (e.g. an application processor or the like) over a network (e.g. the Internet) via a wired or a wireless connection such as WiFi®, Bluetooth® or a mobile telecommunications system which may be based on UMTS, LTE, ultra-low latency 5G or the like (and implements corresponding communication protocols).

The circuitry may include data storage capabilities to store data such as memory which may be based on semiconductor storage technology (e.g. RAM, EPROM, etc.) or magnetic storage technology (e.g. a hard disk drive) or the like.

In some examples, the information processing apparatus may be a communication device being part of a communication system including at least another communication device and a communication network. The communication devices may be in communication with each other via the communication network. The communication network may include wired or unwired communication technologies, such as the Internet, a Local Area Network (LAN), a Wide Area Network (WAN) or any type of packet-switched or circuit-switched network known in the art. The user of the information processing apparatus and the target individual may be in a communication session taking place in the communication network (i.e. virtual communication session such as a video call). In some examples, the communication session is web-conference video call.

In other examples, the information processing apparatus may be a used as a communication device in a real-world communication session. Here, the user and the target individual interact with each other face-to-face in the real world. In such cases, the information processing apparatus may be a smartphone, augmented reality glass, a smart watch or the like.

The target information obtainer, the communication behavior classifier, the direct behavior information determiner, the indirect behavior determiner and the explanator may be based on or may be implemented by the circuitry to achieve the functions as described herein as hardware and/or software code components.

Each of target information obtainer, the communication behavior classifier, the direct behavior information determiner, the indirect behavior determiner and the explanator may be based on or may be implemented by a circuitry, as described herein, to achieve the functions as described herein as hardware and/or software code components.

The information processing apparatus obtains the target information of the target individual.

The target information includes the image information which may be obtained by a camera. In some examples, the camera may include a framed-based image sensor (such as in a conventional RBG camera) or a change detection sensor (e.g. an event-based vision sensor (EVS)) for acquiring image data. The camera may be part of the information processing apparatus.

The image information may include consecutive images, e.g. a video. The image information may be indicative of a body language of the target individual. Therefore, the body language of the target individual is captured (via the camera) and then obtained by the information processing apparatus.

In other examples, the target information may additionally include at least one of audio information, and meta information related to the target individual.

The audio information may be obtained by a microphone which may be part of the information processing apparatus. The audio information may include noise, speech or the like originating from the target individual.

The meta information may include position information and personal information related to the user. In case the target individual is engaged in a virtual communication session, the meta information may be derived from the participant information (of the target individual) used for the virtual communication session (e.g. physical location, profile information, age, connectivity and the like).

In some examples, some of the target information relating to the target individual may also be manually registered beforehand by the user, e.g. by uploading or storing the target information in a storage (e.g. cloud or physical storage) associated with the information processing apparatus.

The information processing apparatus determines, based on the target information, the communication behavior class of the target individual. The communication behavior class indicates the cultural background (if the target individual is a human) or a genus (if the target individual is an animal) of the target individual. As set forth above, a body language may be unique to a communication behavior class or may bear a different meaning depending on the communication behavior class.

In some embodiments, the cultural background may indicate if the target individual is German, French, Italian, Chinese, Korean, Japanese, American, etc. This list is merely exemplary and may include more or less entries. In other examples, the cultural distinction may also be more or less granular.

In some embodiments, the genus of the animal may indicate if the target individual (the animal) is a dog, cat, bird, etc. The animal may be, for example, a pet. This list is merely exemplary and may include more or less entries.

The information processing apparatus determines, based on the target information, direct behavior information about the target individual. In other words, the target information is used for determining the direct behavior information.

The direct behavior information includes or is indicative of the body language of the target individual represented in the image information. In other words, the direct behavior information is readily recognizable in the image information.

The body language may include gestures (e.g. waving, fist making, nodding, hand shaking, bowing, tail wagging, etc.), micro expressions (e.g. eye movement, blinking, shivering), etc.

The direct behavior information may be determined by, e.g. applying a body language recognition to the image information to recognize the body language of the target individual. Known techniques and methods may be used for the body language recognition.

The information processing apparatus determines, based on the communication behavior class (of the target individual) and the direct behavior information (about the target individual), the indirect behavior information of the target individual. The indirect behavior information indicates or includes a meaning conveyed by the direct behavior of the target individual (which indicates the body language of the target individual). The meaning may include for example a state and/or intention.

The meaning conveyed from the direct behavior information may include for example “welcome”, “goodbye”, “thank you”, “anger”, “joy”, “appreciation”, etc. The list is, of course, not exhaustive and further meanings and/or intentions conveyed by respective direct behavior information may be considered.

The information processing apparatus obtains, based on a communication behavior class of a user (of the information processing apparatus), the explanatory information regarding the indirect behavior information. Thus, the explanatory information is dependent on the communication behavior class of the user insofar as the explanatory information is understood by the user. This means, for example, providing the explanatory information in the native language of the user. The communication behavior class of the user may be, for example, registered in a user profile for using the information processing apparatus may be manually provided by the user to the information processing apparatus through a graphical user interface.

The explanatory information is information which indicates the meaning conveyed by the direct behavior. Thus, for example, a body language specific to the culture of the target individual may be translated and/or explained to the user.

The explanatory information may include at least one of text information, audio information, visual information and image information. The visual information may comprise symbols (such as emojis, emoticons, etc.).

The information processing apparatus provides the explanatory information to the user. The explanatory information may be provided via a display unit and/or a speaker, which may be part of the information processing apparatus.

The information processing apparatus may improve in some instances the communication between the target individual and the user. For example, the information processing apparatus enhances the real-time interactions for the user, as well as serve for educational purposes. It can also provide real-time audio translation between the target individual and the user who do not know a common language.

Additionally, since the communication may be improved in some instances, less time is needed for the user to understand the target individual, which in turn leads to less power consumption of the information processing apparatus.

In some embodiments, the indirect behavior information is indicative of a state and/or intention of the target individual. In other words, the indirect behavior information indicates the meaning conveyed by the direct behavior information about the target individual. For example, the indirect behavior information indicates the meaning of a gesture performed by the target individual.

In some embodiments, the target information further includes audio information of the target individual. Thus, the information processing apparatus also obtains the audio information. Thereby, the audio information is used in addition to the image information for determining the communication class behavior of the target individual.

The audio information may be derived from audio data obtained by a microphone. The audio information may indicate a language, accent, dialect or the like specific to communication behavior class (e.g. to a cultural background).

By using audio information, accuracy in determining the communication behavior class of the target individual may be improved in some instances.

In some embodiments, the communication behavior class includes at least one of a cultural background of a human and a genus of an animal.

In some embodiments, the information processing apparatus provides, to the user, a response appropriate for responding to the indirect behavior information. The response may be provided in addition to the explanatory information to the user. For example, the response may include instructions for performing a gesture for responding to the indirect behavior information. The instructions may be provided via text information, audio information or visual information.

Thereby, the communication between the target individual and the user may be facilitated and possible dangerous or unpleasant situations arising from misunderstanding the body language may be prevented.

In some embodiments, the information processing apparatus obtains and provides the explanatory information to the user only when the user belongs to a different communication behavior class than the target individual. Hence, only when required, explanatory information and, optionally, a response (plan) will be provided to the user for understanding the body language of the target individual. Thereby, processing (steps) of the information processing apparatus may be minimized.

In some embodiments, the image information is acquired from at least one of a change detection sensor or a frame-based image sensor.

In some embodiments, the information processing apparatus obtains the indirect behavior information from a machine learning algorithm into which the target information is input, wherein the machine learning algorithm is trained to determine the indirect behavior information.

In some examples, the machine learning algorithm is trained to determine the indirect behavior information based on the image information and, optionally, other input information such as the audio information and meta information. In other examples, the machine learning algorithm is further trained to determine the communication behavior class and the direct behavior information based on the target information and to determine the indirect behavior information based on the determined communication behavior class and the direct behavior information. Therefore, in some examples, the machine learning algorithm may include or constitute the communication behavior classifier, the direct behavior information determiner and the indirect behavior information determiner of information processing apparatus.

The machine learning algorithm may be a neural network, a support vector machine (SVM), a logistic regression, a decision tree, etc.

In some examples, the machine learning algorithm may be a multimodal neural network for determining the indirect behavior information based on multiple input information, e.g. image information and audio information and, optionally, meta information. For determining the communication behavior class. The multimodal neural network may weight each of the input information to be equally important or may use a predetermined weighting for each of the input information

The machine learning algorithm may be implemented or may run on the media player or a cloud server. The machine learning algorithm may be implemented or may run on a third-party server which provides, for example, artificial intelligence services such as inference by a trained machine learning algorithm.

In some embodiments, the machine learning algorithm is trained with a database prelabeled by an operator. The prelabeled database may include a plurality of scenes of an interaction between a target individual and a user, wherein each of the scenes includes a respective target information, a respective communication behavior class, a respective direct behavior information and a respective indirect behavior information of/about the target individual, wherein each of these information is annotated by the operator. In some examples, the operator can be either a professional or a crowd.

For example, the operator may determine that a communication behavior class of a target individual represented in a scene has a German background and that the target individual performs a waving gesture with his hand. Accordingly, the operator determines a respective direct behavior information to include said waving gesture and determines a respective indirect behavior information to include the intention of the target individual to greet someone.

The database may be expanded and improved as the information processing apparatus is used. Annotation may be done by taking into account user feedback, who could indicate new situations or when the explanator's explanatory information, responses and suggestion were incorrect according to user. This feedback may be verified by professionals before being included in the prelabeled database.

Some embodiments pertain to an information processing method including:
obtaining target information of a target individual, wherein the target information includes image information;
determining, based on the target information, a communication behavior class of the target individual;
determining, based on the target information, direct behavior information about the target individual;
determining, based on the communication behavior class and the direct behavior information, indirect behavior information of the target individual; and
obtaining, based on a communication behavior class of a user, explanatory information regarding the indirect behavior information and providing the explanatory information to the user.

The information processing method may be performed by the information processing apparatus as described herein.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Returning to FIG. 1, an information processing apparatus 1 according to a first embodiment is schematically illustrated in a block diagram.

A user U of the information processing apparatus 1 engages in a real-world communication session with a target individual T which is a human individual from a first cultural background, e.g. German, and speaks a first language, e.g. German. The user U has a second cultural background different from the first cultural background, e.g. Japanese, and is not a native speaker in the first language. In FIG. 1, the target individual T performs a waving gesture which is specific to the first cultural background and the meaning of which is not known to the user U. The target individual T and, therefore, the waving gesture is recorded by a camera C configured obtain image information and, optionally, audio information of the target individual T as target information. The image information includes consecutive images of the target individual T and the audio information includes sound from the target individual.

In order to facilitate communication for the user U, the information processing apparatus 1 provides explanatory information to the user U explaining the meaning of the waving gesture.

To this end, the information processing apparatus 1 is configured as schematically illustrated as block diagram in FIG. 1.

The information processing apparatus 1 includes a target information obtainer 10, a communication behavior classifier 20, a direct behavior information determiner 30, an indirect behavior information determiner 40 and an explanator 50.

The target obtainer 10 is configured to obtain the image information of the target individual T. In some examples, the target obtainer 10 may include the camera C. In other examples, the target obtainer 10 may obtain, via a communication interface, the target information about the target individual T from the camera C.

The communication behavior classifier 20 obtains the target information and determines a communication behavior class of the target individual. In the case illustrated in FIG. 1, the target individual T belongs to the communication behavior class “German”.

The direct behavior information 30 obtains the target information and uses the target information to determine a direct behavior information of the target individual T. In other words, the direct behavior information 30 is configured to recognize a body language of the target individual T. In the case illustrated in FIG. 1, the direct behavior information is indicative of the waving gesture performed by the target individual T. In some examples, the direct behavior information may be the waving gesture itself.

The indirect behavior information determiner 40 obtains the communication behavior class (e.g. “German”) from the communication behavior classifier 20 and the direct behavior information (e.g. “waving”) from the direct behavior information determiner 30. The indirect behavior determiner 40 determines the indirect behavior information which is indicative of the meaning conveyed by the direct behavior information.

To this end, the indirect behavior information determiner 40 uses a table 60 stored in a database (not shown) and illustrated in FIG. 2.

With reference to FIG. 2, the table 60 includes a plurality of direct behavior information G1, G2, G3, . . . and corresponding indirect behavior information M_{A}, M_{B}, M_{C}, M_{D}, . . . indicating their meaning in the different communication behavior classes CBC1, CBC2, CBC3, CBC4, . . . . Generally, same indices with respect to the direct behavior information and the indirect behavior information represent the same gesture or meaning, whereas different indices represent different gestures and meanings.

As an example, in table 60, the first communication behavior class CBC1 indicates “German” as a cultural background, the second communication behavior class CBC2 indicates “Japanese” as a cultural background, the third communication behavior class CBC3 indicates “dog” as a genus of an animal and the fourth communication behavior class CBC4 indicates “cat” as a genus of an animal, and so on. Typically, the target individual T may be classified into one of the communication behavior classes CBC1, CBC2, CBC3, CBC4, ( . . . ).

Further, in the present example, the first direct behavior information G1 indicates a waving gesture, first direct behavior information G2 indicates a nodding gesture and G3 indicates the gesture of wagging a tail.

Here, in the present example, the direct behavior information G1 indicating a waving gesture with the hand has a first meaning M_{A} for the first communication behavior class CBC1 (German) and a different second meaning M_{B} for the second communication behavior class CBC2 (Japanese). The first meaning M_{A} indicates a greeting which is conveyed by the waving, whereas the second meaning M_{B} indicates “I do not know” when asked a question.

Therefore, when a Japanese person interacts with a German person who is waving, there may be initial confusion with regards to that specific gesture.

Further, in the present example, the direct behavior information G2 indicating a nodding gesture has the same meaning M_{C} for the first and second communication behavior class CBC1, CBC2, i.e. agreement or acknowledgment.

Further, in the present example, the direct behavior information G3 (wagging tail) has a fourth meaning M_{D} indicating joy for the third communication behavior class (dog) and a fifth meaning M_{E} indicating anger for the fourth communication class (cat).

Returning to FIG. 1, the indirect behavior information determiner 40 uses the table 60 and the obtained information, i.e. the direct behavior information and communication class behavior relating to the target individual T, to determine the meaning of the body language (e.g. gesture).

For example, the indirect behavior information determiner 40 obtains that the target individual T belongs to the first communication behavior class CBC1 (German) and the first direct behavior information G1 (waving). Thereby, the indirect behavior determiner 40 determines based on the first communication behavior CBC1, the first direct behavior information G1 and the table 60 that the target individual T intention is to greet the user U.

The explanator 50 obtains the indirect behavior information determined from the indirect behavior information determiner 40. Further, the explanator 50 obtains the communication behavior class of the user U, as described herein.

The explanator 50 provides the explanatory information to the user U via a display unit and/or speaker (not shown). The explanator 50 provides the explanatory information in such a way that the user understands the indirect behavior information. Thereby, the understanding of certain culture specific gestures for the user U can be improved and thus the communication between the user U and the target individual T.

In the present example, the explanator 50 obtains the first indirect behavior information M_{A} indicating a greeting of the target individual T. Then, the explanator 50 provides the explanatory information relating to the first indirect behavior information M_{A} to the user U who belongs to communication behavior class CBC2 (Japanese). Here, the explanatory information may be, e.g. a text output or a voice output in Japanese, a depiction of a corresponding gesture used in Japanese culture for a greeting, etc.

Further, the explanator 50 may optionally provide a response (plan) which is to be carried out by user U to respond appropriately to the direct behavior information related to the target individual. Thus, the communication between the user U and the target individual T can be improved.

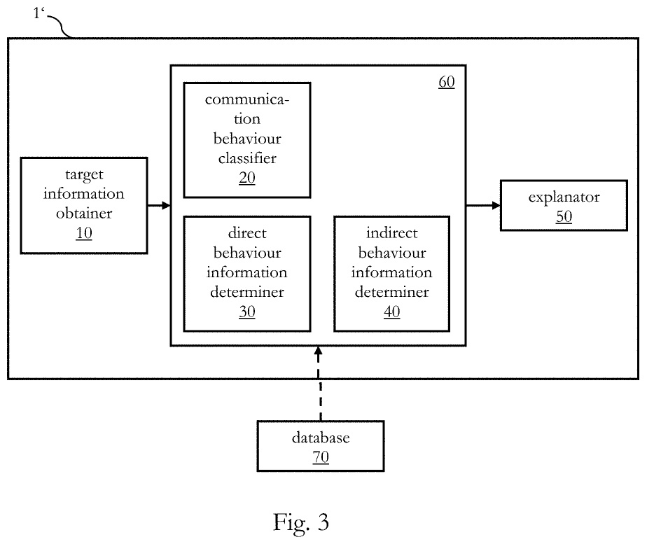

FIG. 3 illustrates schematically in a block diagram the second embodiment of the information processing apparatus 1′.

The information processing apparatus 1′ according to the second embodiment includes, similarly to the first embodiment, the target information obtainer 10, the communication behavior classifier 20, the direct behavior information determiner 30, the indirect behavior information determiner 40 and the explanator 50, whose functions correspond to the respective ones as described above with respect the first embodiment.

The information processing apparatus 1′ further includes a machine learning algorithm 60, which includes the communication behavior classifier 20, the direct behavior information determiner 30, the indirect behavior information determiner 40.

The machine learning algorithm 60 obtains the target information from the target information obtainer 10 and uses the target information to determine the indirect behavior information. The target information obtainer 10 is the same as explained with respect to the first embodiment and further explanation will be therefore omitted.

The machine learning algorithm 60 includes or corresponds to the communication behavior classifier 20, the direct behavior information determiner 30, the indirect behavior information determiner 40, since the machine learning algorithm 60 is trained to determine the communication behavior class of the target individual T (which is the function of the communication behavior classifier 20), to determine the direct behavior information about the target individual T (which is the function of the direct behavior information determiner 30) and to determined the indirect behavior information (which is the function of the indirect behavior information determiner 40).

The machine learning algorithm 60 analyzes the target information to obtain the communication behavior class of the target individual T represented in the target information. Depending on the communication behavior class, the machine learning algorithm 60 analyzes the target information for visual cues and, optionally, auditive cues (i.e. sound cues) (both of which correspond to the direct behavior information) to determine the state and/or intention of the target individual (which corresponds to the indirect behavior information).

The machine learning algorithm 60 is trained with a prelabeled database 70.

The explanator 50 obtains the indirect behavior information from the machine learning algorithm 60. The explanator 50 is the same as explained with respect to the first embodiment and further explanation will be therefore omitted.

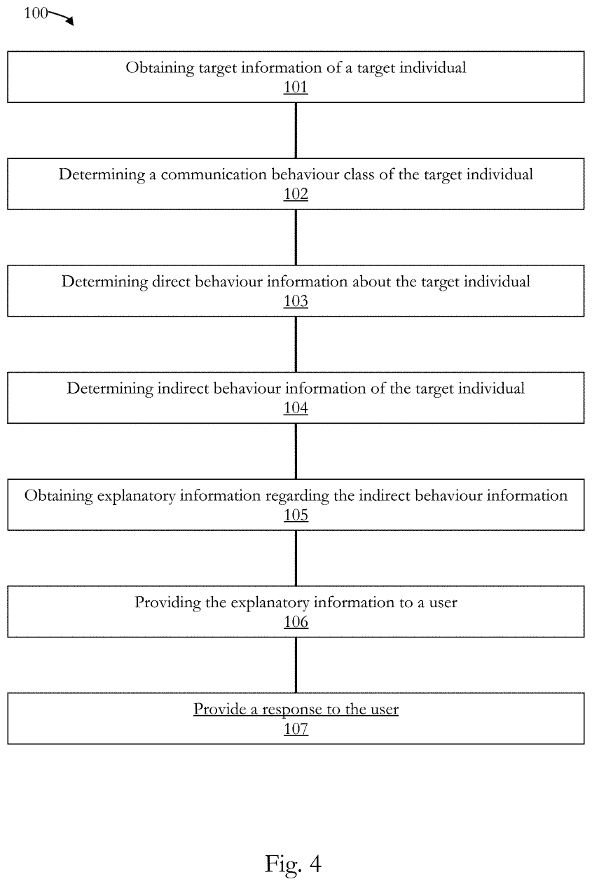

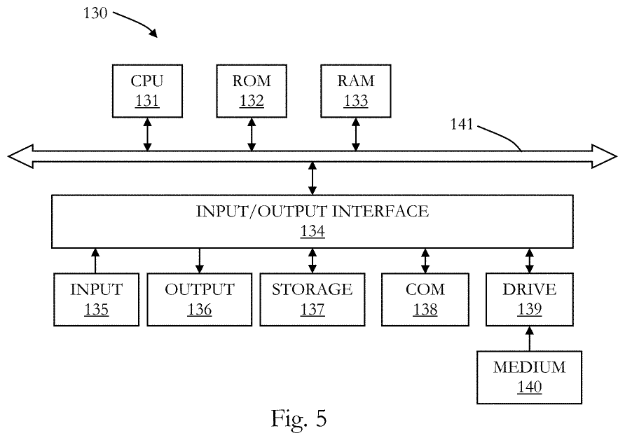

FIG. 4 schematically illustrates in a flow diagram an embodiment of an information processing method 100.

In some embodiments, the information processing method 100 is implemented or formed by the information processing apparatus as described herein.

At 101, target information of a target individual is obtained, as discussed herein.

At 102, a communication behavior class of the target individual is determined, as discussed herein.

At 103, direct behavior information about the target individual is determined, as discussed herein.

At 104, indirect behavior information of the target individual is determined, as discussed herein.

At 105, explanatory information regarding the indirect behavior information is obtained, as discussed herein.

At 106, the explanatory information is provided to a user, as discussed herein.

At 107, a response appropriate for responding to the indirect behavior information is provided to the user, as discussed herein.

FIG. 5 schematically illustrates in a block diagram a general-purpose computer 130 which can be used in some embodiments for implementing an information processing apparatus.

The computer 130 can be implemented in some embodiments such that it can basically function as any type of information processing system as described herein. The computer has components 131 to 141, which form a circuitry in this embodiments, such as any one of the circuitries of the information processing system as described herein.

Embodiments which use software, firmware, programs or the like for performing the methods as described herein can be installed on computer 130 in some embodiments, which is then configured to be suitable for the concrete embodiment.

The computer 130 has a CPU 131 (Central Processing Unit), which can execute various types of procedures and methods as described herein, for example, in accordance with programs stored in a read-only memory (ROM) 132, stored in a storage 137 and loaded into a random access memory (RAM) 133, stored on a medium 140 which can be inserted in a respective drive 139, etc.

The CPU 131, the ROM 132 and the RAM 133 are connected with a bus 141, which in turn is connected to an input/output interface 134. The number of CPUs, memories and storages is only exemplary, and the skilled person will appreciate that the computer 130 can be adapted and configured accordingly for meeting specific requirements which arise, when it functions as an information processing system.

At the input/output interface 134, several components are connected: an input 135, an output 136, the storage 137, a communication interface 138 and the drive 139, into which a medium 140 (compact disc, digital video disc, compact flash memory, or the like) can be inserted.

The input 135 can be a pointer device (mouse, graphic table, or the like), a keyboard, a microphone, a camera, a touchscreen, etc.

The output 136 can have a display (liquid crystal display, cathode ray tube display, light emittance diode display, etc.), loudspeakers, etc.

The storage 137 can have a hard disk, a solid state drive and the like.

The communication interface 138 can be adapted to communicate, for example, via a wired connection or via a local area network (LAN), wireless local area network (WLAN), mobile telecommunications system (GSM, UMTS, LTE, NR (new radio protocol as in 5G) etc.), Bluetooth, infrared, etc.

It should be noted that the description above only pertains to an example configuration of computer 130. Alternative configurations may be implemented with additional or other sensors, storage devices, interfaces or the like. For example, the communication interface 138 may support other radio access technologies than the mentioned UMTS, LTE and NR.

When the computer 130 functions as an information processing system, the communication interface 138 can further have a respective air interface (providing e.g. E-UTRA protocols OFDMA (downlink) and SC-FDMA (uplink)) and network interfaces (implementing for example protocols such as S1-AP, GTP-U, S1-MME, X2-AP, or the like). The computer 130 is also implemented to transmit data in accordance with TCP. Moreover, the computer 130 may have one or more antennas and/or an antenna array. The present disclosure is not limited to any particularities of such protocols.

It should be recognized that the embodiments describe methods with an exemplary ordering of method steps. The specific ordering of method steps is however given for illustrative purposes only and should not be construed as binding.

Herein, “obtaining” may include, for example, sending from a first element to a second (receiving or obtaining) element, optionally based on some triggering condition or data or signal, or there may be a request from the second element to the first element before receiving or obtaining particular signals from the first element.

All units and entities described in this specification and claimed in the appended claims can, if not stated otherwise, be implemented as integrated circuit logic, for example on a chip, and functionality provided by such units and entities can, if not stated otherwise, be implemented by software.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.
(1) An information processing apparatus comprising:
   a target information obtainer configured to obtain target information of a target individual, wherein the target information includes image information;
   a communication behavior classifier configured to determine, based on the target information, a communication behavior class of the target individual;
   a direct behavior information determiner configured to determine, based on the target information, direct behavior information about the target individual;
   an indirect behavior information determiner configured to determine, based on the communication behavior class and the direct behavior information, indirect behavior information of the target individual; and
   an explanator configured to obtain, based on a communication behavior class of a user, explanatory information regarding the indirect behavior information and provide the explanatory information to the user.
(2) The information processing apparatus according to (1), wherein the target individual is a human or an animal.
(3) The information processing apparatus according to (1) or (2), wherein the indirect behavior information is indicative of a state and/or intention of the target individual.
(4) The information processing apparatus according to any one of (1) to (3), wherein the target information further includes audio information of the target individual.
(5) The information processing apparatus according to any one of (1) to (4), wherein the communication behavior class includes at least one of a cultural background of a human and a genus of an animal.
(6) The information processing apparatus according to any one of (1) to (5), wherein the explanator is further configured to provide, to the user, a response appropriate for responding to the indirect behavior information.
(7) The information processing apparatus according to any one of (1) to (6), wherein the explanator is further configured to obtain and provide the explanatory information to the user only when the user belongs to a different communication behavior class than the target individual.
(8) The information processing apparatus according to any one of (1) to (7), wherein the image information is acquired from at least one of a change detection sensor or a frame-based image sensor.
(9) The information processing apparatus according to any one of (1) to (8), wherein indirect behavior determiner is configured to obtain the indirect behavior information from a machine learning algorithm into which the target information is input, wherein the machine learning algorithm is trained to determine the indirect behavior information.
(10) The information processing apparatus according to any one of (1) to (9), wherein the machine learning algorithm is trained with a database prelabeled by an operator.
(11) An information processing method comprising:
   obtaining target information of a target individual, wherein the target information includes image information;
   determining, based on the target information, a communication behavior class of the target individual;
   determining, based on the target information, direct behavior information about the target individual;
   determining, based on the communication behavior class and the direct behavior information, indirect behavior information of the target individual; and
   obtaining, based on a communication behavior class of a user, explanatory information regarding the indirect behavior information and providing the explanatory information to the user.
(12) The information processing method according to (11), wherein the target individual is a human or an animal.
(13) The information processing method according to (11) to (12), wherein the indirect behavior information is indicative of a state and/or intention of the target individual.
(14) The information processing method according to any one of (11) to (13), wherein the target information further includes audio information of the target individual.
(15) The information processing method according to any one of (11) to (14), wherein the communication behavior class includes at least one of a cultural background of a human and a genus of an animal.
(16) The information processing method according to any one of (11) to (15), further comprising:
   providing, to the user, a response appropriate for responding to the indirect behavior information.
(17) The information processing method according to any one of (11) to (16), wherein obtaining and providing the explanatory information to the user is performed only when the user belongs to a different communication behavior class than the target individual.
(18) The information processing method according to any one of (11) to (17), further comprising:
   obtaining the target information from at least one of a change detection sensor or a frame-based image sensor.
(19) The information processing method according to any one of (11) to (18), wherein the indirect behavior information is obtained from a machine learning algorithm into which the target information is input, wherein the machine learning algorithm is trained to determine the indirect behavior information.
(20) The information processing method according to any one of (11) to (19), further comprising:
   training the machine learning algorithm with a database prelabeled by an operator.
(21) A computer program comprising program code causing a computer to perform the method according to anyone of (11) to (20), when being carried out on a computer.
(22) A non-transitory computer-readable recording medium that stores therein a computer program product, which, when executed by a processor, causes the method according to anyone of (11) to (20) to be performed.

1. An information processing apparatus comprising:
a target information obtainer configured to obtain target information of a target individual, wherein the target information includes image information;
a communication behavior classifier configured to determine, based on the target information, a communication behavior class of the target individual;
a direct behavior information determiner configured to determine, based on the target information, direct behavior information about the target individual;
an indirect behavior information determiner configured to determine, based on the communication behavior class and the direct behavior information, indirect behavior information of the target individual; and
an explanator configured to obtain, based on a communication behavior class of a user, explanatory information regarding the indirect behavior information and provide the explanatory information to the user.

2. The information processing apparatus according to claim 1, wherein the target individual is a human or an animal.

3. The information processing apparatus according to claim 1, wherein the indirect behavior information is indicative of a state and/or intention of the target individual.

4. The information processing apparatus according to claim 1, wherein the target information further includes audio information of the target individual.

5. The information processing apparatus according to claim 1, wherein the communication behavior class includes at least one of a cultural background of a human and a genus of an animal.

6. The information processing apparatus according to claim 1, wherein the explanator is further configured to provide, to the user, a response appropriate for responding to the indirect behavior information.

7. The information processing apparatus according to claim 1, wherein the explanator is further configured to obtain and provide the explanatory information to the user only when the user belongs to a different communication behavior class than the target individual.

8. The information processing apparatus according to claim 1, wherein the image information is acquired from at least one of a change detection sensor or a frame-based image sensor.

9. The information processing apparatus according to claim 1, wherein indirect behavior determiner is configured to obtain the indirect behavior information from a machine learning algorithm into which the target information is input, wherein the machine learning algorithm is trained to determine the indirect behavior information.

10. The information processing apparatus according to claim 9, wherein the machine learning algorithm is trained with a database prelabeled by an operator.

11. An information processing method comprising:
obtaining target information of a target individual, wherein the target information includes image information;
determining, based on the target information, a communication behavior class of the target individual;
determining, based on the target information, direct behavior information about the target individual;
determining, based on the communication behavior class and the direct behavior information, indirect behavior information of the target individual; and
obtaining, based on a communication behavior class of a user, explanatory information regarding the indirect behavior information and providing the explanatory information to the user.

12. The information processing method according to claim 11, wherein the target individual is a human or an animal.

13. The information processing method according to claim 11, wherein the indirect behavior information is indicative of a state and/or intention of the target individual.

14. The information processing method according to claim 11, wherein the target information further includes audio information of the target individual.

15. The information processing method according to claim 11, wherein the communication behavior class includes at least one of a cultural background of a human and a genus of an animal.

16. The information processing method according to claim 11, further comprising:
providing, to the user, a response appropriate for responding to the indirect behavior information.

17. The information processing method according to claim 11, wherein obtaining and providing the explanatory information to the user is performed only when the user belongs to a different communication behavior class than the target individual.

18. The information processing method according to claim 11, further comprising:
obtaining the target information from at least one of a change detection sensor or a frame-based image sensor.

19. The information processing method according to claim 11, wherein the indirect behavior information is obtained from a machine learning algorithm into which the target information is input, wherein the machine learning algorithm is trained to determine the indirect behavior information.

20. The information processing method according to claim 19, further comprising:
training the machine learning algorithm with a database prelabeled by an operator.
